(19) United States
(12) Patent Application Publication
(10) Pub. No.: US 2013/0155291 A1
(43) Pub. Date: Jun. 20, 2013

(54) ELECTRONIC CAMERA

(71) Applicant: SANYO ELECTRIC CO., LTD., Moriguchi-shi (JP)

(72) Inventors: Masayoshi Okamoto, Daito-shi (JP); Jun Kiyama, Higashiosaka-shi (JP); Tatsuya Shiratori, Daito-shi (JP); Takahiro Hori, Shijonawate-shi (JP)

(73) Assignee: SANYO ELECTRIC CO., LTD., Moriguchi-shi (JP)

(21) Appl. No.: 13/720,434

(22) Filed: Dec. 19, 2012

(30) Foreign Application Priority Data
Dec. 19, 2011 (JP) 2011-277598

(51) Int. Cl. H04N 5/225; H04N 5/262

(52) U.S. Cl. CPC H04N 5/225; H04N 5/262
USPC 348/240.1; 348/222.1

(57) ABSTRACT

An electronic camera includes an imager. An imager has an imaging surface capturing an optical image representing a scene, and repeatedly outputs an electronic image corresponding to the optical image. An adjuster adjusts an imaging condition with reference to a partial image belonging to an adjustment area assigned to the imaging surface. A searcher repeatedly searches for a specific object image from the electronic image. An updater updates an arrangement of the adjustment area in a manner different depending on an attribute of the specific object image. A setter sets the arrangement of the adjustment area to a predetermined arrangement when a time period during which non-detection of the searcher continues has reached a threshold value. A controller controls a magnitude of the threshold value so that the magnitude increases as a specific object equivalent to the specific object image is close to a center of the scene.

### CROSS REFERENCE OF RELATED APPLICATION

The disclosure of Japanese Patent Application No. 2011-277598, which was filed on Dec. 19, 2011, is incorporated herein by reference.

### BACKGROUND OF THE INVENTION

1. Field of the Invention

The present invention relates to an electronic camera, and in particular, relates to an electronic camera which adjusts an imaging condition by noticing a specific object appeared in a scene captured on an imaging surface.

2. Description of the Related Art

According to one example of this type of camera, a focus frame structure which defines an image referred to in a contrast AF process is set in a manner different depending on detection/non-detection of a face of a person. That is, the focus frame structure is set to a fixed position when the face is not detected, and the focus frame structure is set to a center of the face when the face is detected.

However, in the above-described camera, an arrangement of the focus frame structure is varied resulting from a repeat of success/failure of a face detection, and thereby, a performance of adjusting the imaging condition may be deteriorated.

### SUMMARY OF THE INVENTION

An electronic camera according to the present invention comprises: an imager, having an imaging surface capturing an optical image representing a scene, which repeatedly outputs an electronic image corresponding to the optical image; an adjuster which adjusts an imaging condition with reference to a partial image belonging to an adjustment area assigned to the imaging surface out of the electronic image outputted from the imager; a searcher which repeatedly searches for a specific object image from the electronic image outputted from the imager; an updater which updates an arrangement of the adjustment area in a manner different depending on an attribute of the specific object image detected by the searcher; a setter which sets the arrangement of the adjustment area to a predetermined arrangement when a time period during which non-detection of the searcher continues has reached a threshold value; and a controller which controls a magnitude of the threshold value so that the magnitude increases as a specific object equivalent to the specific object image detected by the searcher is close to a center of the scene.

According to the present invention, an imaging control program recorded on a non-transitory recording medium in order to control an electronic camera provided with an imager, having an imaging surface capturing an optical image representing a scene, which repeatedly outputs an electronic image corresponding to the optical image, the program causing a processor of the electronic camera to perform the steps, comprises: an adjusting step of adjusting an imaging condition with reference to a partial image belonging to an adjustment area assigned to the imaging surface out of the electronic image outputted from the imager; a searching step of repeatedly searching for a specific object image from the electronic image outputted from the imager; an updating step of updating an arrangement of the adjustment area in a manner different depending on an attribute of the specific object image detected by the searching step; a setting step of setting the arrangement of the adjustment area to a predetermined arrangement when a time period during which non-detection of the searching step continues has reached a threshold value; and a controlling step of controlling a magnitude of the threshold value so that the magnitude increases as a specific object equivalent to the specific object image detected by the searching step is close to a center of the scene.

An electronic camera according to the present invention comprises: an imager, having an imaging surface capturing an optical image representing a scene, which repeatedly outputs an electronic image corresponding to the optical image; an adjuster which adjusts an imaging condition with reference to a partial image belonging to an adjustment area assigned to the imaging surface out of the electronic image outputted from the imager; a searcher which repeatedly searches for an object image representing a specific object from the electronic image outputted from the imager; an updater which updates an arrangement of the adjustment area in a manner different depending on an attribute of the object image detected by the searcher; and a setter which sets the arrangement of the adjustment area to a predetermined arrangement when a time period during which non-detection of the searcher continues has reached a threshold value increasing as the specific object image is close to a center of the scene.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a basic configuration of one embodiment of the present invention;

FIG. 2 is a block diagram showing a configuration of one embodiment of the present invention;

FIG. 3 is an illustrative view showing one example of an assignment state of an evaluation area on an imaging surface;

FIG. 4 (A) is an illustrative view showing one example of a scene captured before zooming;

FIG. 4 (B) is an illustrative view showing one example of a scene captured after zooming;

FIG. 5 (A) is an illustrative view showing one example of an assignment state of an adjustment area;

FIG. 5 (B) is an illustrative view showing another example of the assignment state of the adjustment area;

FIG. 6 (A) is an illustrative view showing another example of the scene captured before zooming;

FIG. 6 (B) is an illustrative view showing another example of the scene captured after zooming;

FIG. 7 (A) is an illustrative view showing still another example of the assignment state of the adjustment area;

FIG. 7 (B) is an illustrative view showing yet another example of the assignment state of the adjustment area;

FIG. 8 is an illustrative view showing one example of a center area and a periphery area on the imaging surface;

FIG. 9 (A) is a timing chart showing one example of a change of a face detecting result;

FIG. 9 (B) is a timing chart showing one example of a change of display/non-display of a face-frame structure character surrounding a face image detected in the center area;

FIG. 9 (C) is a timing chart showing one example of a change of display/non-display of a face-frame structure character surrounding a face image detected in the periphery area;

FIG. 10 is a block diagram showing one example of a configuration of a face detecting circuit applied to the embodiment in FIG. 2;

FIG. 11 is a flowchart showing one portion of behavior of a CPU applied to the embodiment in FIG. 2;

FIG. 12 is a flowchart showing another portion of behavior of the CPU applied to the embodiment in FIG. 2;

FIG. 13 is a flowchart showing still another portion of behavior of the CPU applied to the embodiment in FIG. 2;

FIG. 14 is a flowchart showing yet another portion of behavior of the CPU applied to the embodiment in FIG. 2; and

FIG. 15 is a block diagram showing a configuration of another embodiment of the present invention.

### DETAILED DESCRIPTION OF THE PREFERRED EMBODIMENTS

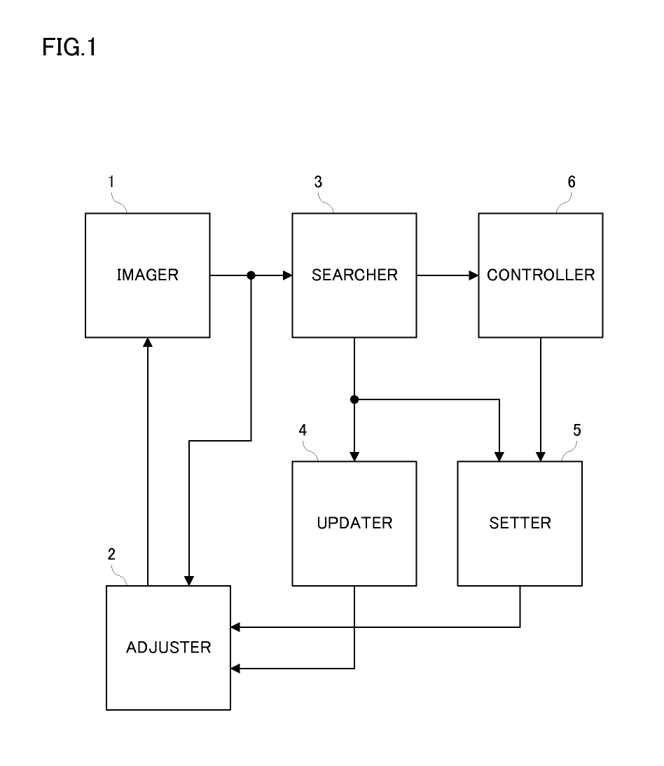

With reference to FIG. 1, an electronic camera according to one embodiment of the present invention is basically configured as follows: An imager 1 has an imaging surface capturing an optical image representing a scene, and repeatedly outputs an electronic image corresponding to the optical image. An adjuster 2 adjusts an imaging condition with reference to a partial image belonging to an adjustment area assigned to the imaging surface out of the electronic image outputted from the imager 1. A searcher 3 repeatedly searches for a specific object image from the electronic image outputted from the imager 1. An updater 4 updates an arrangement of the adjustment area in a manner different depending on an attribute of the specific object image detected by the searcher 3. A setter 5 sets the arrangement of the adjustment area to a predetermined arrangement when a time period during which non-detection of the searcher 3 continues has reached a threshold value. A controller 6 controls a magnitude of the threshold value so the magnitude increases as a specific object equivalent to the specific object image detected by the searcher 3 is close to a center of the scene.

The arrangement of the adjustment area referred to adjust the imaging condition is updated in the manner different depending on the attribute of the detected specific object image, and is set to the predetermined arrangement when the time period during which the non-detection of the specific object image continues has reached the threshold value. Here, the magnitude of the threshold value increases as the specific object is close to the center of the scene. Thereby, it becomes possible to immediately change the imaging condition after the specific object has deviated from the scene while disorder of the imaging condition resulting from temporary-non-detection of the specific object existing in the scene is inhibited. Thus, a performance of adjusting the imaging condition is improved.

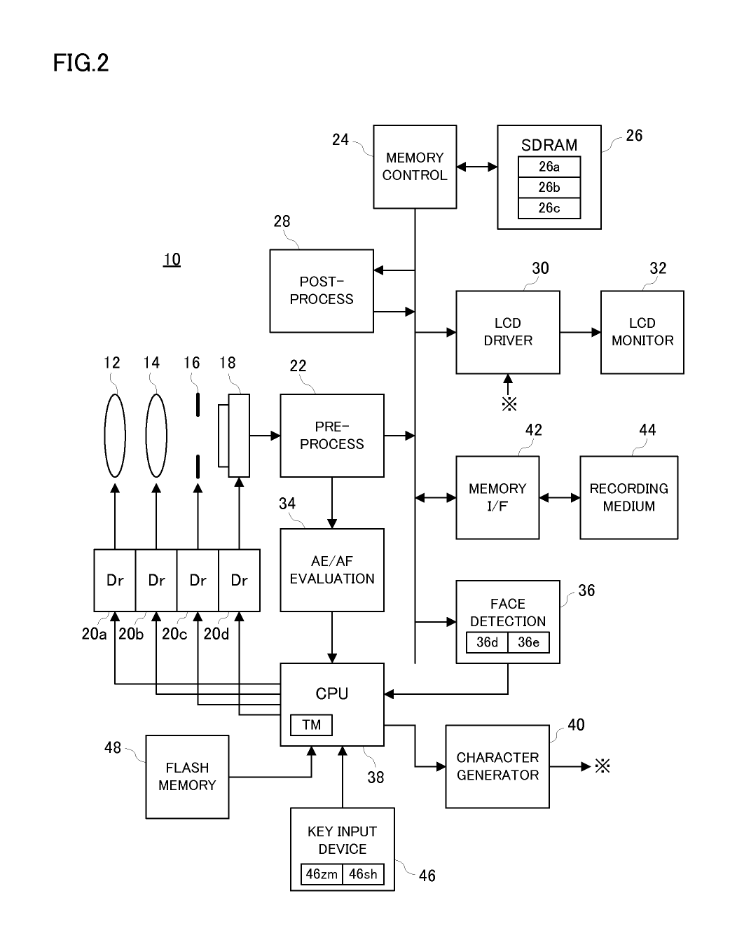

With reference to FIG. 2, a digital camera 10 according to one embodiment includes a zoom lens 12, a focus lens 14 and an aperture unit 16 driven by drivers 20a to 20c, respectively.

An optical image that underwent these components enters, with irradiation, an imaging surface of an imager 18, and is subjected to a photoelectric conversion. Thereby, generated are electric charges corresponding to the optical image.

When a power source is applied, in order to execute a moving-image taking process under an imaging task, a CPU 38 commands a driver 20d to repeat an exposure procedure and an electric-charge reading-out procedure. In response to a vertical synchronization signal Vsync generated at every 1/30th of a second from an SG (Signal Generator) not shown, the driver 20d exposes the imaging surface and reads out the electric charges produced on the imaging surface in a raster scanning manner. From the imager 18, raw image data that is based on the read-out electric charges is outputted at a frame rate of 30 fps.

A pre-processing circuit 22 performs processes, such as digital clamp, pixel defect correction, gain control and etc., on the raw image data outputted from the imager 18. The raw image data on which these processes are performed is written into a raw image area 26a of an SDRAM 26 through a memory control circuit 24.

A post-processing circuit 28 reads out the raw image data stored in the raw image area 26a through the memory control circuit 24, and performs a color separation process, a white balance adjusting process and a YUV converting process, on the read-out raw image data. The YUV formatted image data produced thereby is written into a YUV image area 26b of the SDRAM 26 by the memory control circuit 24.

An LCD driver 30 repeatedly reads out the image data stored in the YUV image area 26b through the memory control circuit 24, and drives an LCD monitor 32 based on the read-out image data. As a result, a real-time moving image (a live view image) representing the scene captured on the imaging surface is displayed on a monitor screen.

When a zoom button 46zm arranged in a key input device 46 is operated, the CPU 38 moves the focus lens 12 in an optical-axis direction through the driver 20a. As a result, a magnification of the live view image is changed.

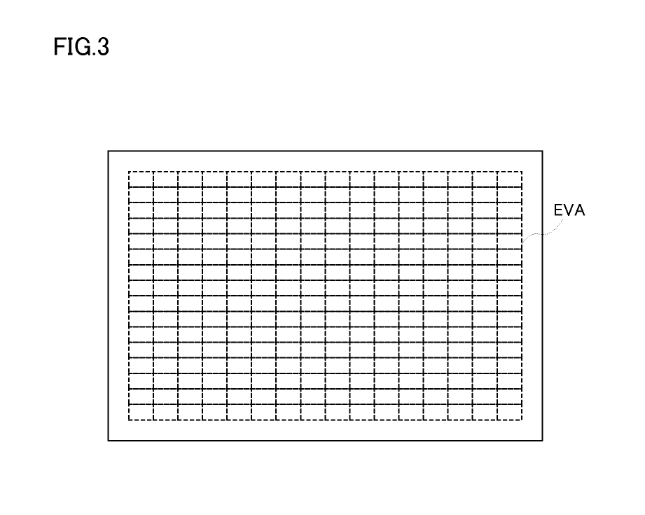

With reference to FIG. 3, an evaluation area EVA is assigned to the imaging surface. The evaluation area EVA is divided into 16 portions in each of a horizontal direction and a vertical direction; therefore, the evaluation area EVA is formed of 256 divided areas. Moreover, in addition to the above-described processes, the pre-processing circuit 22 shown in FIG. 2 executes a simple RGB converting process which simply converts the raw image data into RGB data.

An AE/AF evaluating circuit 34 integrates RGB data belonging to the evaluation area EVA, out of the RGB data produced by the pre-processing circuit 22, at every time the vertical synchronization signal Vsync is generated. Thereby, 256 integral values (256 AE evaluation values) are outputted from the AE/AF evaluating circuit 34 in response to the vertical synchronization signal Vsync.

Moreover, the AE/AF evaluating circuit 34 integrates a high-frequency component of the RGB data belonging to the evaluation area EVA, out of the RGB data generated by the pre-processing circuit 22, at every time the vertical synchronization signal Vsync is generated. Thereby, 256 integral values (256 AF evaluation values) are outputted from the AE/AF evaluating circuit 34 in response to the vertical synchronization signal Vsync.

Moreover, under an imaging assisting task parallel with the imaging task the CPU 38 repeatedly executes a face searching process. Upon face searching process, a searching request is issued toward a face detecting circuit 36 at every time the vertical synchronization signal Vsync is generated, for example, ten times.

The face detecting circuit 36 which has accepted the searching request moves a comparing frame structure placed on image data on the YUV image area 26b in a raster scanning manner from a head position to a tail end position, via an initialization of a register 36e, and compares a characteristic amount of partial image data belonging to the comparing frame structure with a characteristic amount of a face image registered in a dictionary 36d. When image data coincident with the face image registered in the dictionary 36d is detected, the face detecting circuit 36 registers a size and a position of the comparing frame structure at a current time point on the register 36e, and sends back a searching end notification to the CPU 38.

As long as the image data coincident with the face image registered in the dictionary 36d is not detected, the comparing frame structure is reduced at every time reaching the tail end position, and is set again to the head position thereafter. Thereby, comparing frame structures having mutually different sizes are scanned on the image data in a raster direction. The searching end notification is also sent back toward the CPU 38 when a comparing frame structure of a minimum size has reached the tail end position.

In response to the searching end notification sent back from the face detecting circuit 36, the CPU 38 determines whether or not the face image of the person has been detected. When there is any registration in the register 36e, it is determined that the face image has been detected. In contrary, when there is no registration in the register 36e, it is determined that the face image has not been detected.

When the face image is detected, the CPU 38 issues a face-frame-structure character display command toward a character generator 40. The size and position registered in the register 36e are described in the face-frame-structure character display command. The character generator 40 creates character data of a face-frame-structure character FK with reference to a description of the face-frame-structure character display command, and applies the created character data to an LCD driver 30. The LCD driver 30 drives the LCD monitor 32 based on the applied character data, and as a result, the face-frame-structure character FK is displayed on the LCD monitor 32 in an OSD manner.

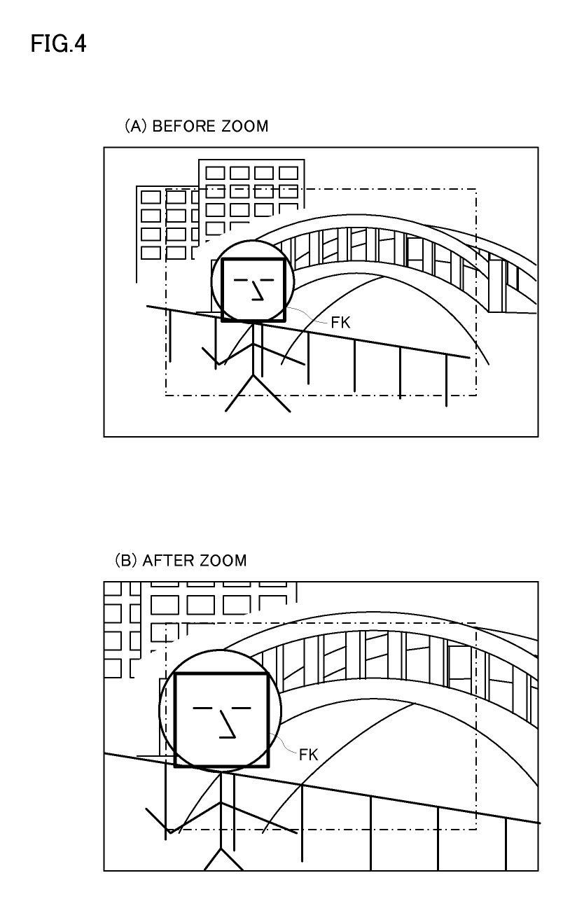

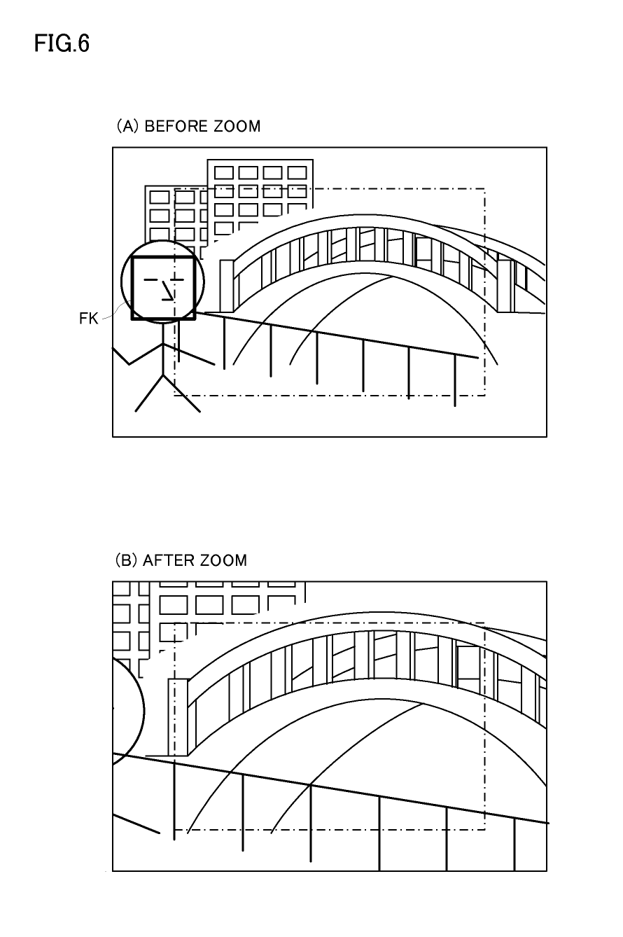

Thus, when a live view image is displayed on the LCD monitor 32 as shown in FIG. 4 (A), FIG. 4 (B) or FIG. 6 (A), the face-frame-structure character FK has a size equivalent to the face image of the person, and is displayed on a position surrounding the face image of the person.

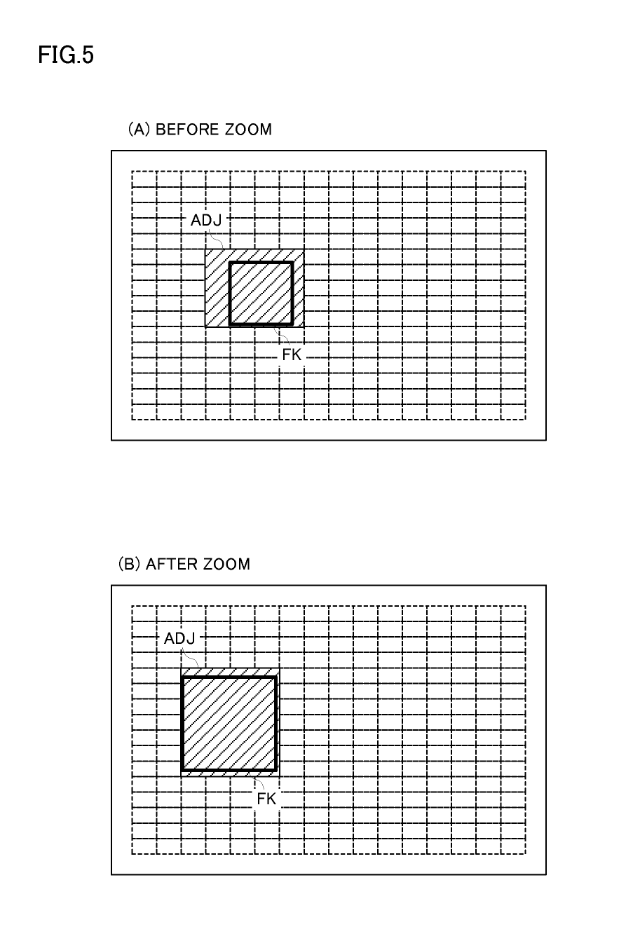

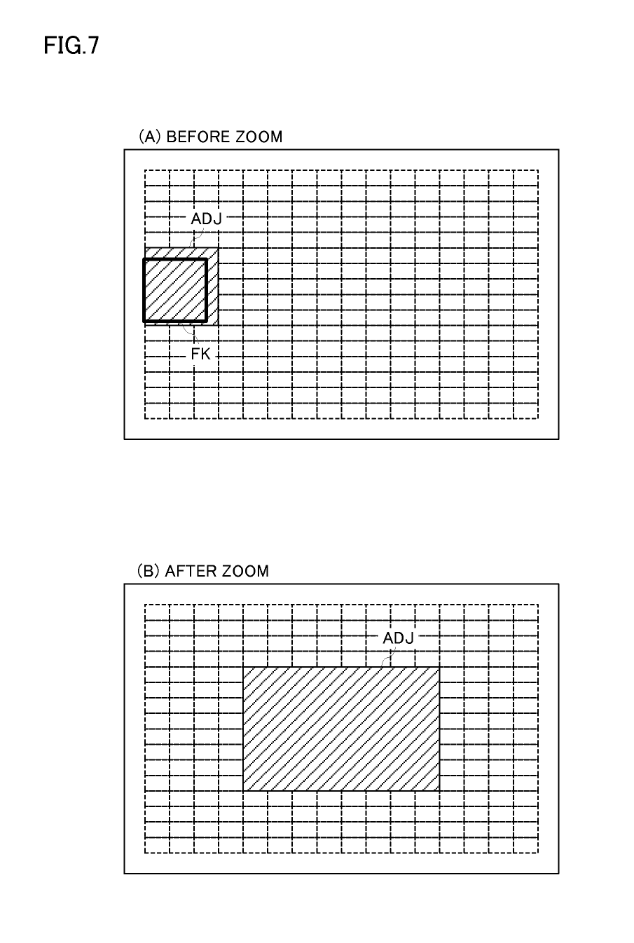

Moreover, the CPU 38 sets partial divided areas covering the face-frame-structure character FK out of the 256 divided areas forming the evaluation area EVA, as an adjustment area ADJ. The adjustment area ADJ is set as follows: as shown in FIG. 5 (A), corresponding to the face-frame-structure character FK displayed as shown in FIG. 4 (A); as shown in FIG. 5 (B), corresponding to the face-frame-structure character FK displayed as shown in FIG. 4 (B); and as shown in FIG. 7 (A), corresponding to the face-frame-structure character FK displayed as shown in FIG. 6 (A).

When the zoom button 46zm is in a non-operated state, the CPU 38 sets a timer value “T_long” to a timer TM at every time the face image is detected. The set timer TM is started immediately. When the face image is no more detected, the CPU 38 waits until the timer TM reaches time-out (time-out: a passage of time period equivalent to the timer value) so as to command the character generator 40 to hide the face-frame-structure character FK, and initializes the setting of the adjustment area ADJ.

As a result, the face-frame-structure character FK disappears from the monitor screen, and the adjustment area ADJ having a predetermined size is assigned to a center of the imaging surface. When the live view image is displayed on the LCD monitor 32 as shown in FIG. 6 (B), the face-frame-structure character FK is hidden, and the adjustment area ADJ is set as shown in FIG. 7 (B).

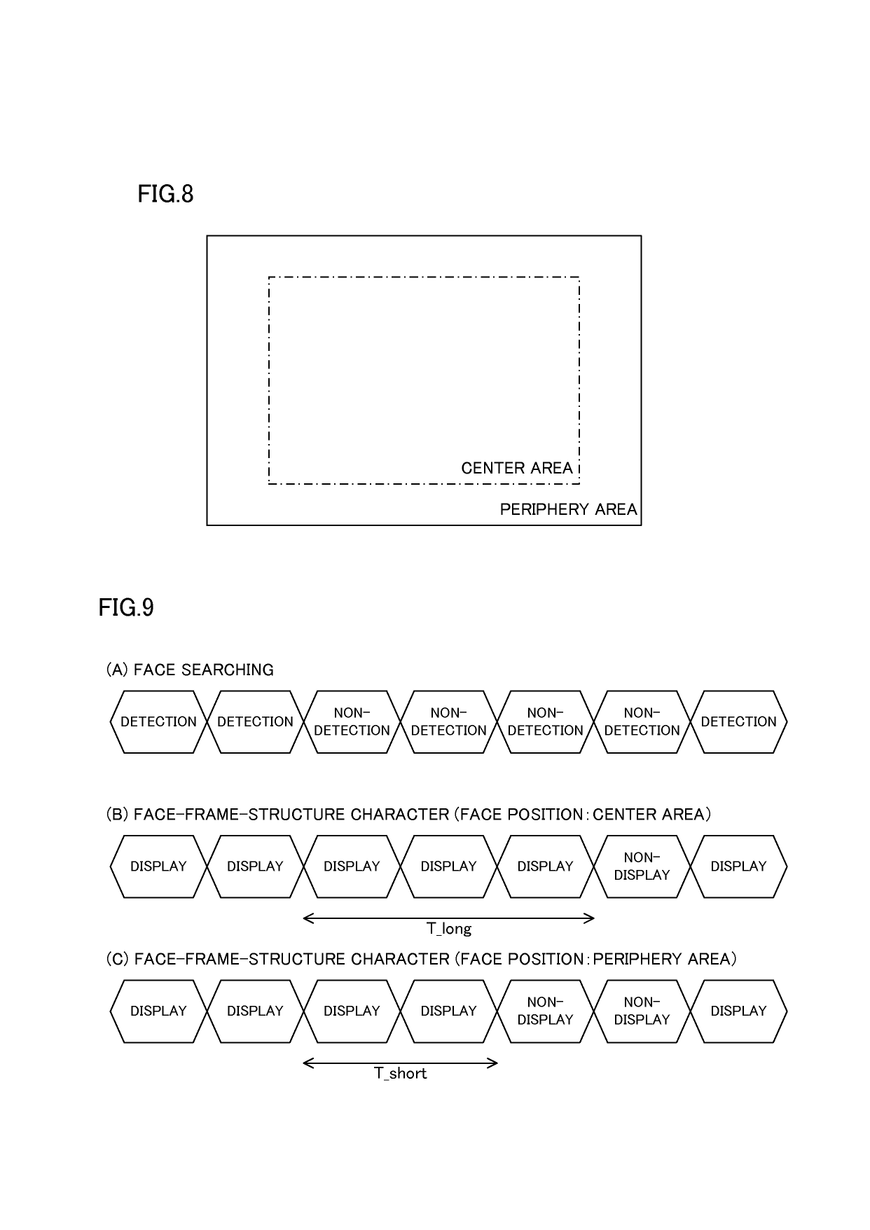

When the zoom button 46zm is in an operated-state, the timer value set to the timer TM at every time the face image is detected is adjusted to a value different depending on a position of the face image. Specifically, when the face image belongs to a center area shown in FIG. 8, the timer value is set to “T_long”. In contrary, when at least a part of the face image deviates from the center area and extends to a periphery area, the timer value is set to “T_short”.

Thus, when a result of the face searching process is changed as shown in FIG. 9 (A), display/non-display of the face-frame-structure character FK is changed as shown in FIG. 9 (B) for the face image belonging to the center area, and is changed as shown in FIG. 9 (C) for the face image at least a part of which extends to the periphery area. That is, a time period from a timing at which the face image is no more detected to a timing at which the face-frame-structure character FK disappears from the monitor screen (=an extra-time-period until an arrangement of the adjustment area ADJ is initialized) is shorten as the position of the face image detected immediately before is close to a periphery of the imaging surface.

Returning to the imaging task, when the shutter button 46sh is in the non-operated state, the CPU 38 extracts, from among the 256 AE evaluation values outputted from the AE/AF evaluating circuit 34, partial AE evaluation values belonging to the adjustment area ADJ defined in a manner described above, and executes a simple AE process based on the extracted AE evaluation values. An aperture amount and an exposure time period defining an appropriate EV value calculated thereby are respectively set to the drivers 20c and 20d. Thereby, a brightness of the live view image is roughly adjusted by using a partial image belonging to the adjustment area ADJ as a reference.

Moreover, the CPU 38 executes a simple AF process (=a continuous AF) based on partial AF evaluation values belonging to the adjustment area ADJ out of the 256 AF evaluation values outputted from the AE./AF evaluating circuit 34. In order to track a focal point, the focus lens 14 is moved in an optical-axis direction by the driver 20a. As a result, a sharpness of the live view image is roughly adjusted by using the partial image belonging to the adjustment area ADJ as a reference.

When the shutter button 46sh is half depressed, the CPU 38 executes a strict AE process referring to the partial AE evaluation values belonging to the adjustment area ADJ so as to calculate an optimal EV value. An aperture amount and an exposure time period defining the calculated optimal EV value also are respectively set to the drivers 20c and 20d. Thereby, a brightness of the live view image is adjusted strictly.

Moreover, the CPU 38 executes a strict AF process based on the partial AF evaluation values belonging to the adjustment area ADJ. The focus lens 14 is moved in the optical-axis direction by the driver 20a in order to search a focal point, and is placed at the focal point discovered thereby. As a result, a sharpness of the live view image is adjusted strictly.

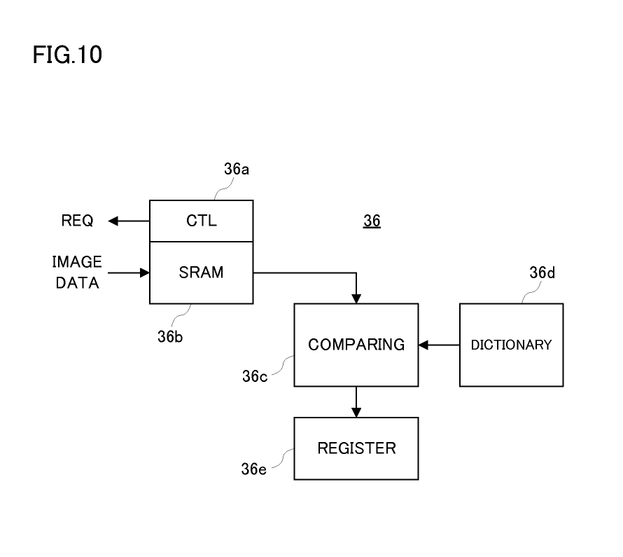

When the shutter button 46sh is fully depressed, the CPU 38 personally executes a still-image taking process, and commands a memory I/F 42 to execute a recording process. One frame of the image data representing a scene at a time point when the shutter button 46sh is fully depressed is evacuated from the YUV image area 26b to a still image area 26c by the still-image taking process. The memory I/F 42 commanded to execute the recording process reads out one frame of the image data evacuated to the still image area 26c through the memory control circuit 24, and records the read-out image data on a recording medium 44 in a file format The face detecting circuit 36 is configured as shown in FIG. 10. A controller 36a assigns a rectangular comparing frame structure to the YUV image area 26b of the SDRAM 26, and reads out a partial image data belonging to the comparing frame structure through the memory control circuit 24. The read-out image data is applied to a comparing circuit 36c via an SRAM 36b.

A dictionary 36d contains a template representing the face image of the person. The comparing circuit 36c compares the image data applied from the SRAM 36b with the template contained in the dictionary 36d. When the template coincident with the image data is discovered, the comparing circuit 36c registers a position and a size of the comparing frame structure at a current time point, onto a register 36e.

The comparing frame structure moves by each predetermined amount in a raster scanning manner, from the head position (an upper left position) toward the tail end position (a lower right position) of the SDRAM 24. Moreover, the size of the comparing frame structure is updated at each time the comparing frame structure reaches the tail end position in the order of “large size” to “intermediate size” to “small size”.

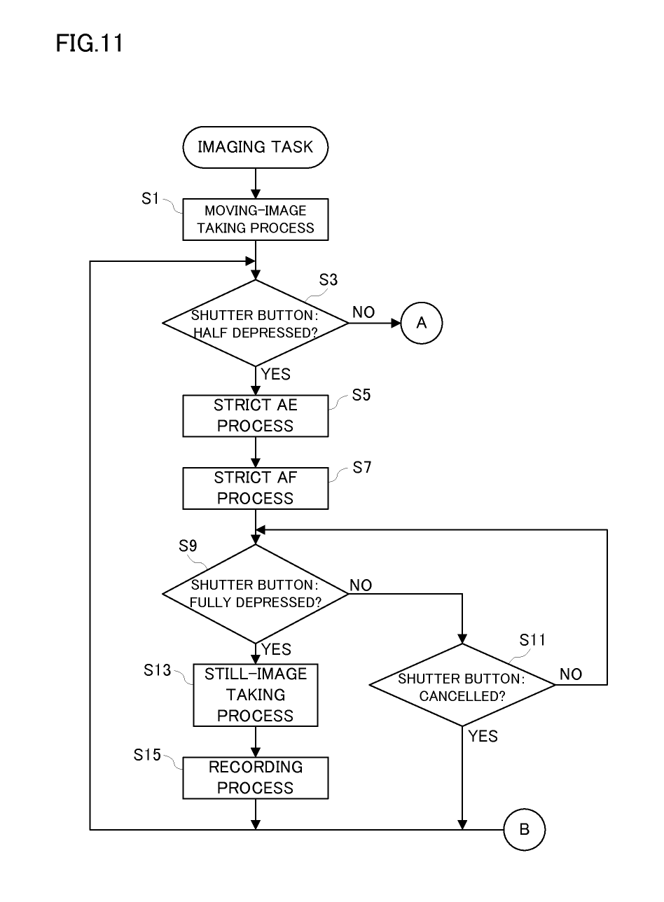

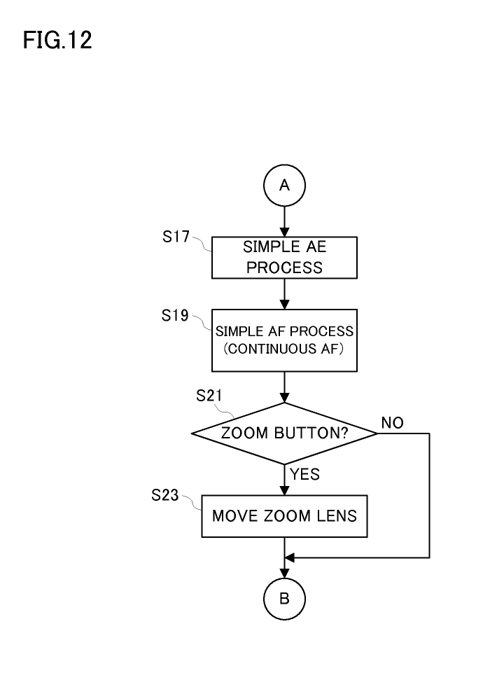

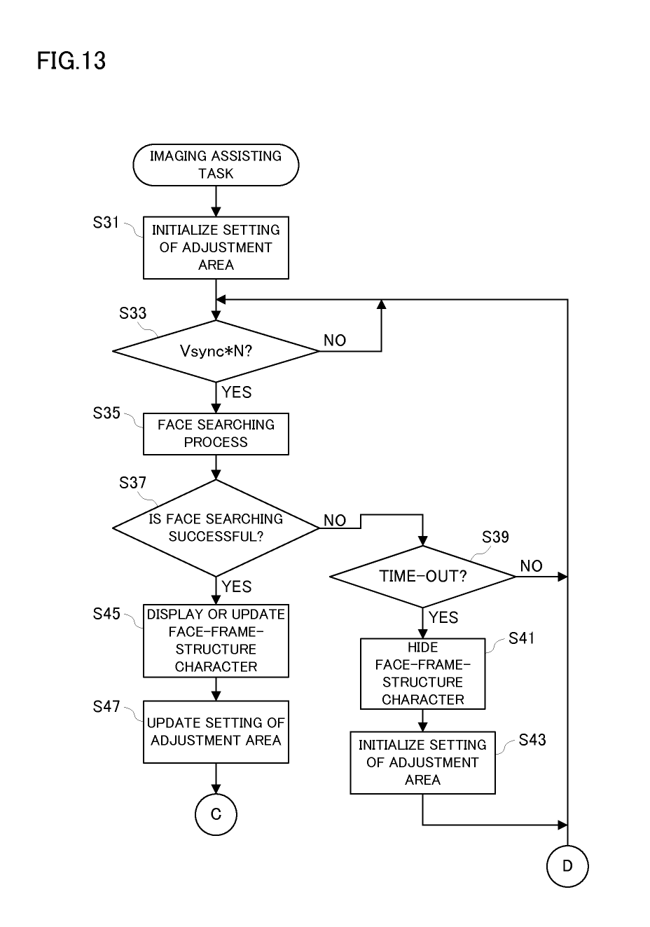

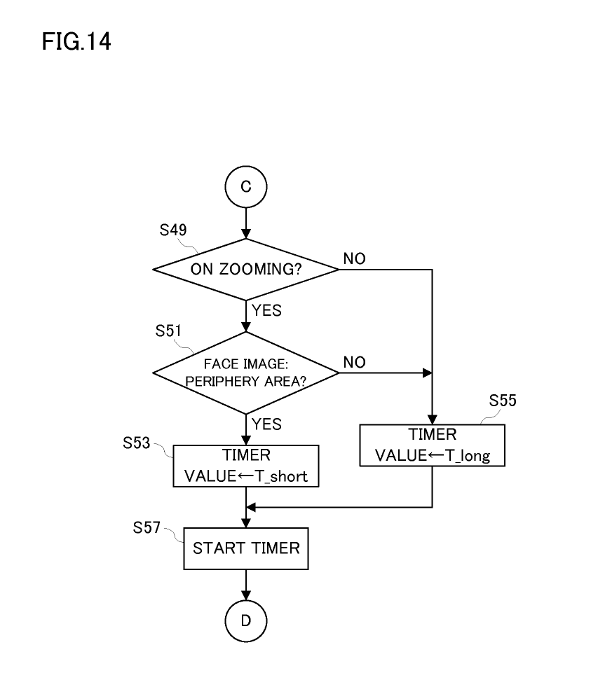

The CPU 38 performs a plurality of tasks including the imaging task shown in FIG. 11 to FIG. 12 and the imaging assisting task shown in FIG. 13 to FIG. 14, in a parallel manner. It is noted that control programs corresponding to these tasks are stored in a flash memory 48.

With reference to FIG. 11, in a step S1, the moving-image taking process is executed. As a result, a live view image representing a scene captured on the imaging surface is displayed on the LCD monitor 32. In a step S3, it is determined whether or not the shutter button 46sh is half-depressed, and when a determined result is NO, the simple AE process and the simple AF process are respectively executed in steps S17 and S19. As a result, a brightness and a sharpness of the live view image are adjusted roughly.

In a step S21, it is determined whether or not the zoom button 46zm is operated, and when a determined result is NO, the process directly returns to the step S3 whereas when the determined result is YES, in a step S23, the focus lens 12 is moved in the optical-axis direction, and thereafter, the process returns to the step S3. As a result of the process in the step S23, a magnification of the live view image is changed.

When the determined result of the step S3 is updated from NO to YES, the strict AE process is executed in a step S5, and the strict AF process is executed in a step S7. A brightness of the live view image is strictly adjusted by the strict AE process, and a sharpness of the live view image is adjusted by the strict AF process.

In a step S9, it is determined whether or not the shutter button 46sh is fully depressed, and in a step S11, it is determined whether or not an operation of the shutter button 46sh is cancelled. When a determined result of the step S11 is YES, the process directly returns to the step S3, and when a determined result of the step S9 is YES, the process returns to the step S3 via processes in steps S13 to S15.

In the step S13, the still-image taking process is executed. As a result, one frame of the image data representing a scene at a time point when the shutter button 46sh is fully depressed is evacuated from the YUV image area 26b to the still image area 26c. In the step S15, the memory I/F is commanded to execute the recording process. The memory I/F 42 reads out one frame of the image data stored in the still image area 26c through the memory control circuit 24, and records the read-out image data on the recording medium 44 in a file format.

With reference to FIG. 13, in a step S31, the setting of the adjustment area ADJ is initialized. The adjustment area ADJ has a predetermined size and is assigned to the center of the imaging surface.

In a step S33, it is determined whether or not the vertical synchronization signal Vsync is generated N times (N: ten, for example). When a determined result is updated from NO to YES, the process advances to a step S35 so as to issue a searching request for the face searching process toward the face detecting circuit 36.

The face detecting circuit 36 moves the comparing frame structure placed on the image data on the YUV image area 26b in a raster scanning manner from the head position to the tail end position, via the initialization of the register 36e, and compares a characteristic amount of partial image data belonging to the comparing frame structure with a characteristic amount of a face image registered in the dictionary 36d. When image data coincident with the face image registered in the dictionary 36d is detected, the face detecting circuit 36 registers a size and a position of the comparing frame structure at a current time point on the register 36e. When the registration to the register 36e is executed or when a minimum size of the comparing frame structure reaches the tail end position, the face detecting circuit 36 sends back the searching end notification to the CPU 38.

When the searching end notification is sent back from the face detecting circuit 36, in a step S37, it is determined whether or not the face image is detected. When there is any registration in the register 36e, it is determined that the face image has been detected, and the process advances to a step S45. In contrary, when there is no registration in the register 36e, it is determined that the face image has not been detected, the process advances to a step S39.

In a step S45, the face-frame-structure character display command is issued toward the character generator 40. The size and position registered in the register 36e are described in the issued face-frame-structure character display command. The character generator 40 creates character data of the face-frame-structure character FK with reference to a description of the face-frame-structure character display command, and applies the created character data to the LCD driver 30. The LCD driver 30 drives the LCD monitor 32 based on the applied character data, and as a result, the face-frame-structure character FK is displayed (or updated) on the LCD monitor 32 in an OSD manner.

In a step S47, partial divided areas covering the face-frame-structure character FK are set as the adjustment area ADJ. Thus, as long as the face image is detected, the arrangement of the adjusting area ADJ is updated in a manner to track the detected face image. In a step S49, it is determined whether or not the operation of the zoom button 46m is being executed, and in a step S51, it is determined whether or not at least a part of the detected face image deviates from the center area.

When both of a determined result of the step S49 and a determined result of the step S51 are YES, in a step S53, the timer value “T_short” is set to the timer TM. In contrary, when at least one of the determined result of the step S49 and the determined result of the step S51 is NO, in a step S55, the timer value “T_long” is set to the timer TM. Upon completion of the process in the step S53 or S55, the timer TM is started in a step S57, and thereafter, the process returns to the step S33.

In the step S39, it is determined whether or not the time-out has occurred, and when a determined result is NO, the process returns to the step S33 whereas when the determined result is YES, the process advances to a step S41. In the step S41, the character generator 40 is commanded to hide the face-frame-structure character FK, and in a step S43, the setting of the adjustment area ADJ is initialized. As a result of the process in the step S41, the face-frame-structure character FK disappears from the monitor screen. Moreover, as a result of the process in the step S43, the adjustment area ADJ having the predetermined size is assigned to the center of the imaging surface. Upon completion of the process in the step S43, the process returns to the step S33.

As can be seen from the above-described explanation, the imager 18 has the imaging surface capturing the optical image representing the scene, and repeatedly outputs the raw image data corresponding to the optical image. The CPU 38 adjusts the exposure amount and the focus based on a partial raw image data belonging to the adjustment area ADJ assigned to the imaging surface out of the raw image data outputted from the imager 18 (S5 to S7, S17 to S19). Moreover, the CPU 38 repeatedly searches for the face image of the person from the YUV formatted image data that is based on the raw image data outputted from the imager 18 (S35), and updates the arrangement of the adjustment area ADJ in a manner different depending on the position and/or size of the detected face image (S47). When the time period during which the non-detection of the face image continues has reached the threshold value, the CPU 38 initializes the arrangement of the adjustment area ADJ (S57, S39 and S43). Here, the magnitude of the threshold value is controlled by the CPU 38 so that the magnitude increases as a face portion equivalent to the detected face image is close to the center of the scene (S51 to S55).

The arrangement of the adjustment area ADJ referred to adjust the exposure amount and the focus is updated in the manner different depending on the position and/or size of the detected face image, and is initialized when the time period during which the non-detection of the face image continues has reached the threshold value. Here, the magnitude of the threshold value increases as the face portion is close to the center of the scene. Thereby, it becomes possible to immediately change the exposure amount and the focus after the face portion has deviated from the scene while disorder of the exposure amount and the focus resulting from the temporary-non-detection of the face portion existing in the scene is inhibited. Thus, the performance of adjusting the imaging condition is improved.

It is noted that, in this embodiment, the face portion of the person is searched, however, a searching target may be a face portion of an animal, and further may be an object other than the face portion. Moreover, in this embodiment, the exposure amount and the focus are assumed as the imaging condition to be adjusted, however, a white balance may be added thereto.

Furthermore, in this embodiment, the timer value “T_long” or “T_short” is set when the zoom button 46zm is in the operated state. However, considering the position of the face image, the timer value may be switched among three or more values.

Moreover, in this embodiment, a photographing and recording of the still image is assumed, however, the moving image may be photographed and recorded instead of the still image or together with the still image.

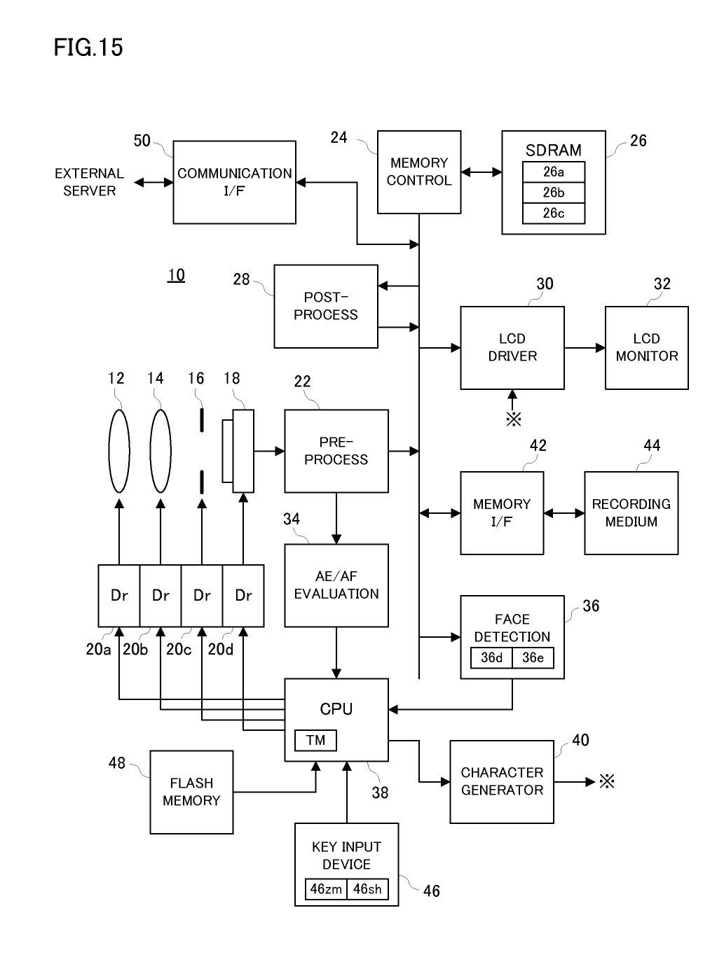

Furthermore, in this embodiment, the control programs equivalent to the multi task operating system and a plurality of tasks executed thereby are previously stored in the flash memory 48. However, a communication I/F 50 may be arranged in the digital camera 10 as shown in FIG. 15 so as to initially prepare a part of the control programs in the flash memory 48 as an internal control program whereas acquire another part of the control programs from an external server as an external control program. In this case, the above-described procedures are realized in cooperation with the internal control program and the external control program.

Moreover, in this embodiment, the processes executed by the CPU 38 are divided into a plurality of tasks in a manner described above. However, these tasks may be further divided into a plurality of small tasks, and furthermore, a part of the divided plurality of small tasks may be integrated into another task. Moreover, when each of tasks is divided into the plurality of small tasks, the whole task or a part of the task may be acquired from the external server.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An electronic camera, comprising:
an imager, having an imaging surface capturing an optical image representing a scene, which repeatedly outputs an electronic image corresponding to the optical image;
an adjuster which adjusts an imaging condition with reference to a partial image belonging to an adjustment area assigned to said imaging surface out of the electronic image outputted from said imager;
a searcher which repeatedly searches for a specific object image from the electronic image outputted from said imager;
an updater which updates an arrangement of said adjustment area in a manner different depending on an attribute of the specific object image detected by said searcher;
a setter which sets the arrangement of said adjustment area to a predetermined arrangement when a time period during which non-detection of said searcher continues has reached a threshold value; and
a controller which controls a magnitude of the threshold value so that the magnitude increases as a specific object equivalent to the specific object image detected by said searcher is close to a center of the scene.

2. An electronic camera according to claim 1, further comprising:
a zoom lens which is arranged in front of said imaging surface;
a changer which changes a distance from said zoom lens to said imaging surface in response to a zoom operation; and
an activator which activates said controller in association with a process of said changer.

3. An electronic camera according to claim 1, wherein said updater sets a partial area covering the specific object image detected by said searcher, as said adjustment area.

4. An electronic camera according to claim 1, wherein the imaging condition noticed by said adjuster includes at least one of a focus and an exposure amount.

5. An electronic camera according to claim 1, wherein the specific object image is equivalent to a face image of a person.

6. An imaging control program recorded on a non-transitory recording medium in order to control an electronic camera provided with an imager, having an imaging surface capturing an optical image representing a scene, which repeatedly outputs an electronic image corresponding to the optical image, the program causing a processor of the electronic camera to perform the steps, comprising:
an adjusting step of adjusting an imaging condition with reference to a partial image belonging to an adjustment area assigned to said imaging surface out of the electronic image outputted from said imager;
a searching step of repeatedly searching for a specific object image from the electronic image outputted from said imager;
an updating step of updating an arrangement of said adjustment area in a manner different depending on an attribute of the specific object image detected by said searching step;
a setting step of setting the arrangement of said adjustment area to a predetermined arrangement when a time period during which non-detection of said searching step continues has reached a threshold value; and
a controlling step of controlling a magnitude of the threshold value so that the magnitude increases as a specific object equivalent to the specific object image detected by said searching step is close to a center of the scene.

7. An electronic camera, comprising:
an imager, having an imaging surface capturing an optical image representing a scene, which repeatedly outputs an electronic image corresponding to the optical image;
an adjuster which adjusts an imaging condition with reference to a partial image belonging to an adjustment area assigned to said imaging surface out of the electronic image outputted from said imager;
a searcher which repeatedly searches for an object image representing a specific object from the electronic image outputted from said imager;
an updater which updates an arrangement of said adjustment area in a manner different depending on an attribute of the object image detected by said searcher; and
a setter which sets the arrangement of said adjustment area to a predetermined arrangement when a time period during which non-detection of said searcher continues has reached a threshold value increasing as the specific object image is close to a center of the scene.
